(19) United States
(12) Patent Application Publication
(10) Pub. No.: US 2021/0075604 A1
(43) Pub. Date: Mar. 11, 2021

(54) KEY GENERATION METHOD

(71) Applicant: STMicroelectronics (Grand Ouest) SAS, Le Mans (FR)

(72) Inventor: Frédéric Ruellé, Marigné-Laillé (FR)

(21) Appl. No.: 17/007,599

(22) Filed: Aug. 31, 2020

(30) Foreign Application Priority Data
Sep. 6, 2019 (FR) 1909823

(51) Int. Cl. H04L 9/08; G06F 8/65; G06F 21/57

(52) U.S. Cl. CPC H04L 9/0866; G06F 2221/033; G06F 21/572; G06F 8/65

(57) ABSTRACT

A key generation method, device and system are disclosed. In an embodiment a method for generating a symmetrical key includes generating, by an electronic device, the symmetrical key as a function of an update program for updating software and a secret value held by the electronic device.

### CROSS-REFERENCE TO RELATED APPLICATIONS

This application claims priority to French Patent Application No. 1909823, filed on Sep. 6, 2019, which application is hereby incorporated herein by reference.

### TECHNICAL FIELD

The present disclosure relates generally to methods for protecting an electronic system, and more specifically to methods for generating encipherment and/or encryption keys.

### BACKGROUND

Cryptography is a discipline aiming inter alia to protect messages sent between two electronic devices or content (ensuring confidentiality, authenticity and integrity) using encryption or encipherment keys. The keys make it possible to encrypt and decrypt the messages. People who do not have the correct keys cannot read the message.

### SUMMARY

Embodiments provide a method for generating a symmetrical key, in which the symmetrical key is generated by an electronic device as a function of a program for updating software and a secret value held by the electronic device.

According to one embodiment, the method comprises the reception by the device of the update program of the software sent by a server.

According to one embodiment, the update program is encrypted.

According to one embodiment, the symmetrical key is also generated by the server.

According to one embodiment, the method comprises a step for generating a first word representative of the update program.

According to one embodiment, the first word is representative of the decrypted update program.

According to one embodiment, the method comprises a step for generating at least one second word, the second word being representative of the secret value.

According to one embodiment, the symmetrical key is generated by applying a key derivation function to the first word and at least one of the second words,

According to one embodiment, the symmetrical key is generated by applying a key derivation function to a third word representative of the first word and one of the second words.

According to one embodiment, the generation of a word is done by a one-way function.

According to one embodiment, the generation of a word is done by a hash function.

According to one embodiment, the secret value is a key having been written in a non-volatile memory during the initial programming of the software.

According to one embodiment, the secret value is a key having been generated during a previous update of the software.

According to one embodiment, the secret value is an identifier of the device.

Another embodiment provides an electronic circuit comprising means for carrying out the method previously described.

Another embodiment provides an electronic system, comprising a server and at least one electronic device, the server and the at least one electronic device comprising a circuit as previously described.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows a system of electronic devices to which the described embodiments apply;

FIG. 2 illustrates a method in block diagram according to an embodiment method for generating a key;

FIG. 3 illustrates a method in block diagram according to another embodiment method for generating a key;

FIG. 4 illustrates a method in block diagram according to yet another embodiment method for generating a key;

FIG. 5 illustrates a method in block diagram according to a further embodiment method for generating a key; and

FIG. 6 illustrates an exemplary functional situation of the system of FIG. 1.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the elements that can be used to send messages, for example between electronic devices and a server, will not be described in detail, the described embodiments being compatible with all of the known transmission elements.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

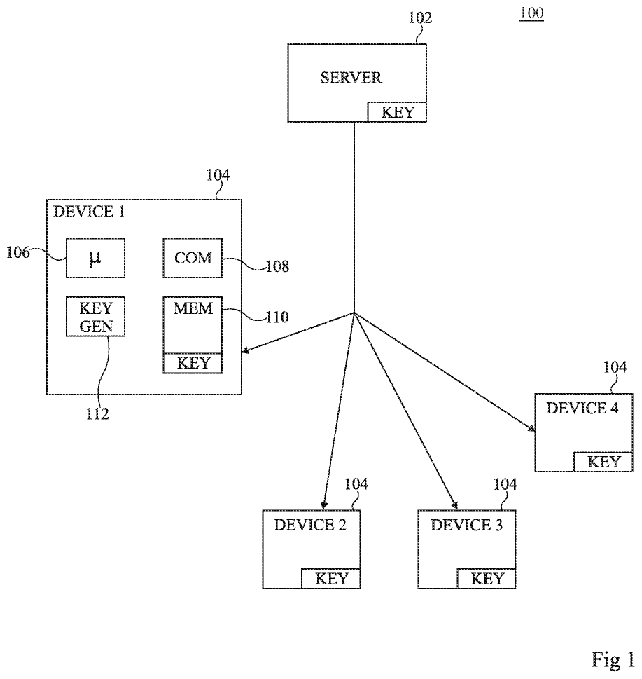

FIG. 1 shows a system of electronic devices of the type to which the described embodiments apply.

FIG. 1 shows an electronic system 100 comprising electronic devices. More specifically, the system 100 comprises a server 102 (SERVER) and devices 104 (DEVICE1, DEVICE2, DEVICE3, DEVICE4). The electronic system 100 comprises at least one device 104, preferably at least two devices 104. Although only one device 104 (DEVICE1) is described in detail, the devices 104 are preferably similar.

The devices 104 are configured to be able to receive data from the server 102, and optionally, to be able to send data to the server 102. The server 102 regularly sends software updates to the devices 104. The devices 104 can optionally be configured to send data between them without going through the server 102.

The data transmitted between the devices 104 and the server 102 or between the devices 104 is preferably encrypted so as to protect it from pirates or third parties seeking to obtain it illegitimately. In order to encrypt the transmitted data, the server 102 and the devices 104 each comprise at least one encryption key (KEY).

Preferably, the encipherment and/or encryption keys are symmetrical keys. Thus, for example during a data transmission between the server 102 and one or several of the devices 104, the server 102 encrypts the data using a symmetrical encryption key and the device(s) 104 decrypt it, after reception, using the same key as that which allowed the encryption of the message.

The devices 104 for example all have the same key to encrypt/decrypt the data transmitted between the devices 104 and the server 102. The server 102 may then comprise only a single key to encrypt/decrypt the data transmitted with the devices 104.

As a variant, the devices 104 can each have their own encryption key. The server 102 then has as many encryption keys as the system comprises devices 104. Data to be transmitted is then encrypted with the key corresponding to the device 104 for which the data is intended. When one wishes to send data to all of the devices 104, each device 104 receives the encrypted data with its encryption key.

Alternatively, the server 102 and the devices 104 can comprise private keys and public keys making it possible to encrypt/decrypt data asymmetrically.

It is possible to seek, for various reasons, to modify the key(s) regularly, for example to ensure that they are not known by a third party. However, it is risky, in terms of computer security, to send a new encryption key directly, even encrypted, particularly if there is a risk that the preceding key will no longer be secured.

The devices 104 for example each comprise a processor 106 (μ), a communication circuit 108 (COM) configured to allow the transmission of data between the device 104 and a circuit outside the device 104, for example the server 102, one or several memories 110 (MEM), including a non-volatile memory and optionally a volatile memory (for example a RAM memory), comprising, inter alia, the encipherment and/or encryption key(s) and one or several programs of the software of the device, and a circuit 112 (KEY GEN) representing the parts of the device configured to generate the new key.

The generation, by the circuit 112, of the new key is for example done by means of software, in which case the circuit 112 comprises a processor, for example the processor 106 or another one. The generation, by the circuit 112, of the new key can also for example be done by the hardware, that is to say, by circuits and logic gates, in which case the circuit 112 comprises the hardware used.

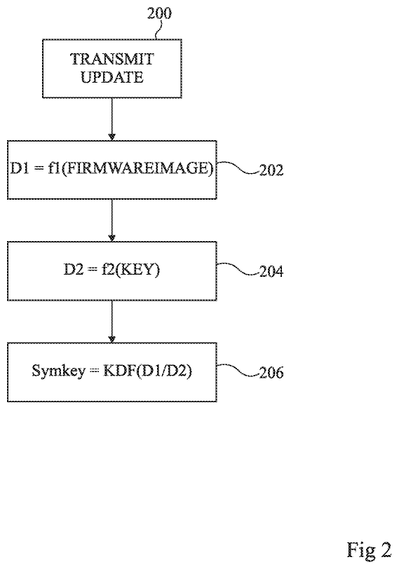

Embodiments of methods for generating symmetrical keys are described in relation with FIGS. 2 to 5. The generated symmetrical keys can be encipherment and/or encryption keys. One element common to all of the described embodiments is that they comprise the local generation of a key as a function of the software update. These methods are preferably applied each time a device 104 receives a software update program (for example, “firmware image”).

FIG. 2 shows an embodiment of a method for generating, or updating, a symmetrical key. The key is generated from a software update program and a secret value, here a previous key.

The generating, or update, method comprises a step 200 (TRANSMIT UPDATE) during which the server 102 (FIG. 1) supplies a software update program to all of the devices 104. The transmitted program has been encrypted by an encryption key, preferably a symmetrical key only being used for the transmission of updates, for example a key supplied to the device during its initial programming, and stored in a non-volatile memory. The key generated by the method described here will preferably not be used to transmit updates, but to transmit other messages. As previously described, if the different devices each have their own symmetrical key, the program is encrypted separately for each device with the corresponding key.

The update program transmitted during step 200 is for example available to the devices 104 during a given period. Thus, the devices can obtain it, or download it, and decrypt it with their symmetrical key, during this period. Thus, the server 102 for example keeps the current key(s) at least during this entire period.

The method of FIG. 2 will be described hereinafter, only considering the server 102 and a single device 104. It is of course understood that this method is carried out in parallel by all of the devices 104 when they receive a software update.

During a following step 202 (D1=f1(FIRMWAREIMAGE)), a word D1 representative of the update program is generated by the device 104 by applying a function f1( ) to the software update program. The function f1( ) is preferably a one-way function, that is to say, a function whose input value is impossible to obtain from the result. The function f1( ) is for example a hash function, for example the so-called SHA256 function. The function f1( ) is for example a function for generating a signature.

Preferably, the software update program is decrypted by using the current symmetrical key and the function f1( ) is applied to the decrypted program. This makes it possible to make it more difficult for a pirate to obtain the word D1, even if the transmission of the software update program is intercepted. Alternatively, the function f1( ) can be applied to the encrypted software update program.

During a following step 204 (D2=f2(KEY)), a word D2 representative of a preceding symmetrical key is generated by applying a function f2( ) to a preceding symmetrical key.

The preceding key is for example a key supplied to the device 104 during the initial programming of the system, for example an OEM (Original Equipment Manufacturer) key, different from the key used for the transmission of the updates. This same preceding key is for example used to generate the word D2 upon each software update.

The preceding key is for example a key having been generated during the preceding software update, by the same method for generating a symmetrical key.

The function f2( ) is preferably the same function as the function f1( ) The function f2( ) can, however, be another function, preferably a one-way function, for example another hash function, for example another function for generating a signature.

Steps 202 and 204 are of course interchangeable. It is thus possible to carry out step 204 before step 202. It is also possible to carry out steps 202 and 204 at the same time.

During a following step 206 (Symkey=KDF(D1/D2)), the new symmetrical key (SymKey), that is to say, the updated symmetrical key, is generated from the words D1 and D2 by applying a key derivation function KDF( ) to the words D1 and D2. For example, the function KDF( ) can be applied to the concatenation D1/D2 of the words D1 and D2.

The key derivation function KDF( ) is for example a hash key derivation function HKDF. The key derivation function KDF( ) is for example a signature generating function.

The server 102 performs, before or after step 200 for transmission of the software update program, steps 202, 204 and 206 from same elements (keys, encrypted or decrypted program) in order to obtain the same key.

When one considers all of the devices 104 of the system 100, the devices 104 preferably all carry out the same method. However, it is possible for the devices 104 to carry out the method with different preceding keys KEY. The devices 104 therefore all obtain a new key SymKey that is specific to them.

In the case where each device 104 obtains a key that is specific to it, the server 102 carries out the method as many times as there are devices 104 so as to generate the new keys of all of the devices 104.

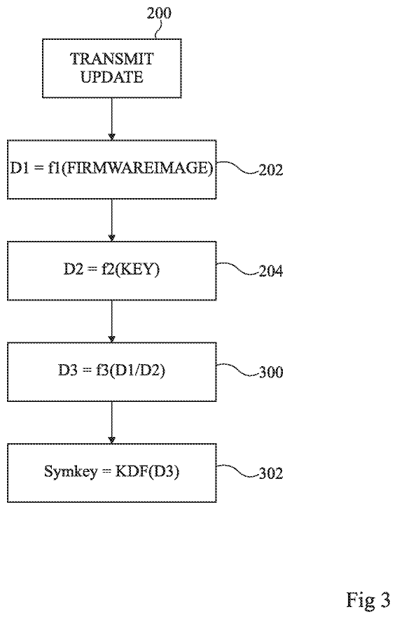

FIG. 3 shows another embodiment of a method for generating, or updating, a symmetrical key. The key is generated from a software update program and a secret value, here a previous key.

The method of FIG. 3 comprises steps similar to those of the method of FIG. 2. In particular, the method of FIG. 3 comprises, for each device 104:
step 200, during which the encrypted software update program is transmitted by the server 102 to the devices 104 of the system 100, this program next being decrypted by each device 104;
step 202, during which the word D1 representative of the software update program is generated by applying the function f1( ) to the encrypted or decrypted software update program; and
step 204, during which the word D2 representative of the preceding encryption key is generated by applying the function f20 to the preceding key.

As previously described, steps 202 and 204 are of course interchangeable. It is thus possible to carry out step 204 before step 202. It is also possible to carry out steps 202 and 204 at the same time.

The method of FIG. 3 next comprises a step 300 (D3=f3(D1/D2)) during which a word D3 representative of the words D1 and D2 is generated. The word D3 is obtained by applying a function f3( ) to the words D1 and D2, for example to the concatenation D1/D2 of the words D1 and D2.

The function f3( ) is for example the same function as the function f1( ) and/or the function f20. The function f3( ) is for example another one-way function. The function f3( ) is for example a function making it possible to ensure that the word D3 has a size smaller than the concatenation D1/D2 of the words D1 and D2, for example having the same size as the word D1 and/or as the word D2.

During a following step 302 (Symkey=KDF(D3)), the new encryption key SymKey is obtained by applying the key derivation function KDF( ) to the third word D3.

The server 102 performs, before or after step 200 for transmission of the software update program, steps 202, 204, 300 and 302 from same elements (keys, encrypted or decrypted program) in order to obtain the same key(s).

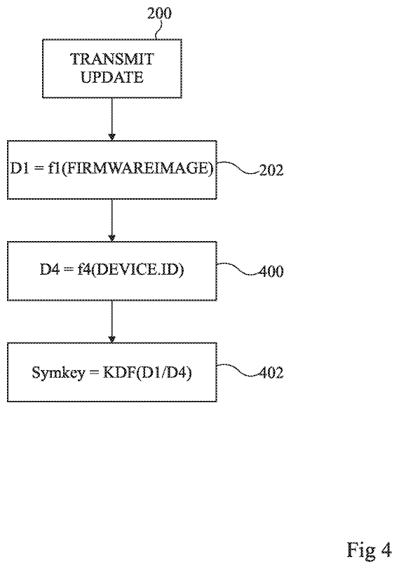

FIG. 4 shows another embodiment of a method for generating, or updating, a symmetrical key. The key is generated from a software update program and a secret value, here a secret word.

The method of FIG. 4 comprises steps similar to those of the methods of FIGS. 2 and 3. In particular, the method of FIG. 4 comprises, for each device 1o4:
step 200, during which the encrypted software update program is transmitted by the server 102 to the devices 104 of the system 100, this program next being decrypted by each device 1o4; and
step 202, during which the word D1 representative of the software update program is generated by applying the function f1( ) to the encrypted or decrypted software update program.

During a following step 400 (D4=f4(DEVICE.ID)), a word D4 is generated by each device 104. The words D4 generated by the devices 104 can all be different from one another. Indeed, each word D4 is representative of a secret word preferably known only by the server 102 and the corresponding device 104. Each word D4 is generated by applying a function f4( ) to the secret word.

The secret word is for example an identification number of the device 104 (DEVICE.ID). The identification number can for example be determined and programmed during the initial programming of the system. As a variant, the identification number can be a Physical Unclonable Function (PUF), that is to say, preferably a random number associated with an electronic device by a physical characteristic.

The function f4( ) is for example the same function as the function f1( ) The function f4( ) is for example another one-way function. The function f4( ) is for example a hash function. The function f4( ) is for example a function for generating a signature.

Steps 202 and 400 are of course interchangeable. It is thus possible to carry out step 400 before step 202. It is also possible to carry out steps 202 and 400 at the same time.

During a following step 402 (Symkey=KDF(D1/D2)), the new symmetrical key (SymKey), that is to say, the updated symmetrical key, is generated from the words D1 and D4 by applying a key derivation function KDF( ) to the words D1 and D4. More specifically, the function KDF( ) can be applied to the concatenation D1/D4 of the words D1 and D4.

The key derivation function KDF( ) is for example a hash key derivation function HKDF. The key derivation function KDF( ) is for example a signature generating function.

The server 102 performs, before or after step 200 for transmission of the software update program, steps 202, 400 and 402 from same elements (keys, encrypted or decrypted program) in order to obtain the same keys.

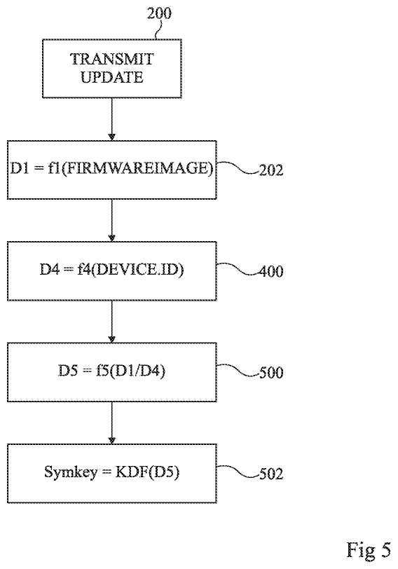

FIG. 5 shows another embodiment of a method for generating, or updating, a symmetrical key. The key is generated from a software update program and a secret value, here a secret word.

The method of FIG. 5 comprises steps similar to those of the method of FIG. 4. In particular, the method of FIG. 5 comprises, for each device 104:
step 200, during which the encrypted software update program is transmitted by the server 102 to the devices 104 of the system 100, this program next being decrypted by each device 104;
step 202, during which the word D1 representative of the software update program is generated by applying the function f1( ) to the encrypted or decrypted software update program; and
step 400, during which the word D4 representative of the secret word associated with the device 104 is generated by applying the function f4( ) to the secret word.

As previously described, steps 202 and 400 are of course interchangeable. It is thus possible to carry out step 400 before step 202. It is also possible to carry out steps 202 and 400 at the same time.

The method of FIG. 5 next comprises a step 500 (D5=f5(D1/D4)) during which a word D5 representative of the words D1 and D4 is generated. The word D5 is obtained by applying a function f5( ) to the words D1 and D4, for example to the concatenation of the words D1 and D4.

The function f5( ) is for example the same function as the function f1( ) and/or the function f4( ). The function f5( ) is for example the same function as the function f3( ) of FIG. 3. The function f5( ) is for example another one-way function. The function f5( ) is for example a function making it possible to ensure that the word D5 has a size smaller than the concatenation D1/D4 of the words D1 and D4, for example having the same size as the word D1 or as the word D4.

During a following step 502 (Symkey=KDF(D5)), the new symmetrical key SymKey is obtained by applying a key derivation function KDF( ) to the word D5.

The server 102 performs, before or after step 200 for transmission of the software update program, steps 202, 400, 500 and 502 from same elements (keys, encrypted or decrypted program) in order to obtain the same keys.

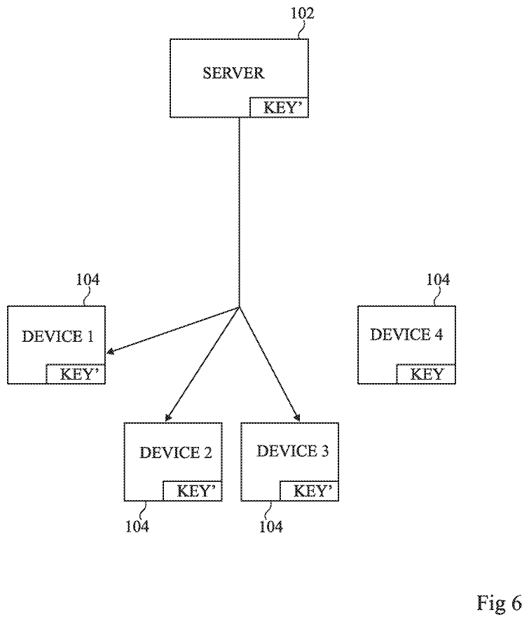

FIG. 6 illustrates an exemplary functional situation of a system of the type of that of FIG. 1.

In the example of FIG. 6, the devices 104 DEVICE1, DEVICE2 and DEVICE3 have received, for example by downloading it, the software update program. These devices have generated, using a generating method as described in relation with FIG. 2, 3, 4 or 5, a new symmetrical key KEY′. Likewise, the server 102 has generated the new symmetrical key KEY′.

However, in this example, the device 104 DEVICE4 did not receive, or download, the update program while it was available. This is for example due to a pirate attack disrupting the software. Thus, the device 104 therefore has the non-updated symmetrical key KEY, and it cannot access the data transmitted by the server 102. This makes it possible to prevent a device whose security is compromised from accessing encrypted data and compromising the security of the entire system.

One advantage of certain embodiments, in which a new symmetrical key is previously generated, is that they make it possible to ensure that all of the updates have been received by the device 104.

One advantage of certain embodiments, in which a new key is always generated from the same secret value, is that this makes it possible to ensure that if a key is discovered by a third party, for example a pirate, the next key will nevertheless be secret. Additionally, the secret value is never transmitted outside the device and the server, which makes it possible to ensure that the secret value is not discovered.

One advantage of the embodiments in which each device has its own up-to-date key is that the transmissions between the server 102 and one of the devices 104 are secured relative to the other devices 104. It is therefore not possible for a device 104 to decrypt a message intended for another device 104.

Various embodiments and variants have been described. Those skilled in the art will understand that certain features of these embodiments can be combined and other variants will readily occur to those skilled in the art. In particular, it is possible to add other steps to the embodiments of methods for generating a symmetrical key, for example other steps for generating words. In particular, it is possible to use the first word D1 with any combination of words D1, D2, D3, D4 and D5 to generate the new encryption key.

Additionally, it is possible to apply additional functions to the different words during the different embodiments of methods for generating an encryption key.

Finally, the practical implementation of the embodiments and variants described herein is within the capabilities of those skilled in the art based on the functional description provided hereinabove.

What is claimed is:

1. A method for generating a symmetrical key comprising:
generating, by an electronic device, the symmetrical key as a function of an update program for updating software and a secret value held by the electronic device.

2. The method according to claim 1, further comprising receiving, by the electronic device, the update program from a server.

3. The method according to claim 2, wherein the update program is encrypted.

4. The method according to claim 2, wherein the symmetrical key is also generated by the server.

5. The method according to claim 1, further comprising generating a first word representative of the update program.

6. The method according to claim 5, wherein the first word is representative of a decrypted update program.

7. The method according to claim 5, wherein generating the symmetrical key comprises applying a key derivation function to the first word and at least one second word.

8. The method according to claim 5, wherein generating the symmetrical key comprises applying a key derivation function to a third word representative of the first word and one second word.

9. The method according to claim 5, wherein generating the first word comprises generating the first word by a one-way function.

10. The method according to claim 5, wherein generating the first word comprises generating the first word by a hash function.

11. The method according to claim 1, further comprising generating at least one second word, the second word being representative of the secret value.

12. The method according to claim 1, wherein the secret value is a key written in a non-volatile memory during initial programming of the software.

13. The method according to claim 1, wherein the secret value is a key generated during a previous update of the software.

14. The method according to claim 1, wherein the secret value is an identifier of the electronic device.

15. The electronic device comprising:
a processor; and
a non-transitory computer-readable storage medium configured to store a program for execution by the processor, the program including instructions to perform the method according to claim 1.

16. An electronic system comprising:
a server; and
at least one electronic device according to claim 15.

17. A method for generating a symmetrical key comprising:
generating, by an electronic device, the symmetrical key as a function of an update program for updating software and a secret value held by the electronic device;
generating a first word representative of the update program; and
generating at least one second word, the second word being representative of the secret value,
wherein generating the symmetrical key comprises applying a key derivation function to the first word and at least one of the second words.

18. A method for generating a symmetrical key comprising:
generating, by an electronic device, the symmetrical key as a function of an update program for updating software and a secret value held by the electronic device;
generating a first word representative of the update program; and
generating at least one second word, the second word being representative of the secret value,
wherein generating the symmetrical key comprises applying a key derivation function to a third word representative of the first word and one of the second words.
